(19) United States
(12) Patent Application Publication
(10) Pub. No.: US 2011/0302437 A1
(43) Pub. Date: Dec. 8, 2011

(54) SWITCH-OFF OF A MICRO CONTROLLER UNIT IN BATTERY MODE

(75) Inventors: Youcef Haddab, Paris (FR); Andrew Lancaster, Seneca, SC (US); Eric Plainecassagne, Versailles (FR); Dhia Saleem, Clemson, SC (US)

(73) Assignee: ITRON, INC., Liberty Lake, WA (US)

(21) Appl. No.: 12/795,245

(22) Filed: Jun. 7, 2010

(51) Int. Cl. G06F 1/32

(52) U.S. Cl. 713/323

(57) ABSTRACT

Disclosed are apparatus and methodology for providing battery protection for devices operating in a battery supplied low-power mode. Micro controller operated devices (such as electricity meters) that may be stored for extended periods after manufacture and before deployment are provided backup battery protection by insertion of an overcurrent operable switch between the battery and the micro controller. A timer causes the micro controller to switch to a normal power mode after a predetermined time period during which no external supply voltage is provided. Normal power mode operation under battery powered supply only will cause the overcurrent switch to open, so as to disconnect the battery from the micro controller. Alternatively, instead of switching the micro controller to a normal power mode after a predetermined time period, the battery powered supply is shorted to ground using an internal switch of the micro controller, to achieve the same result of disconnecting the battery from the micro controller.

### FIELD OF THE INVENTION

The present subject matter relates to Micro Controller Units (MCUs) (hereinafter also “micro controllers”). More specifically, the present subject matter relates to the preservation of critical data when MCUs are operated for extended periods in battery mode.

### BACKGROUND OF THE INVENTION

Micro Controller Units (MCUs) in meter registers are usually backed-up by a battery to save the absolute time as well as some critical parameters in case of power failure. As is known, MCUs have low-power modes intended to minimize the current draw on any associated battery. Even so, the battery will be exhausted if the meter remains without power for too long. If, for example, a meter is stored for several months before deployment by a customer, the backup battery may become completely drained.

U.S. Pat. No. 5,107,203 to Timko, entitled Sealed Utility Meter Having Internal Automatic Disconnections” describes a utility meter incorporating a tilt sensitive switch oriented during shipping and storage as aided by shipping package marking to disengage an internal battery from the internal electronics. At installation of the meter at an appropriate mounting angle, the tilt switch permits connection of the battery.

U.S. Pat. No. 5,216,357 to Coppola et al., entitled “Real Time Solid State Register Having Battery Backup” describes a power outage detector in a utility meter that powers down the meter's microprocessor and connects a backup battery to an external clock upon loss of power.

U.S. Pat. No. 6,992,463 to Yoshio, entitled “Battery Protection Circuit” describes a battery protection circuit that monitors battery discharge and turns off FET switches to attempt to correct abnormalities. Upon failure to correct the abnormalities via turn off of the switches, the circuit causes a fuse in the battery line to blow.

The above referenced patents are for all purposes hereby incorporated by reference into this disclosure as if fully set forth herein.

While various implementations of Micro Controller Units (MCUs) in meter registers have been developed, and while various combinations of battery saving systems have been developed, no design has emerged that generally encompasses all of the desired characteristics as hereafter presented in accordance with the subject technology.

### SUMMARY OF THE INVENTION

In view of the recognized features encountered in the prior art and addressed by the present subject matter, an improved methodology for turning off Micro Controller Units (MCUs) in meter registers has been developed. In an exemplary configuration, the present subject matter relates to a method for switching off a battery backed up micro controller comprising providing a micro controller and an associated backup battery; providing an overcurrent switch between the battery and micro controller, starting a timer upon determination that an external supply voltage to the micro controller has dropped below a predetermined value, and operating the micro controller in a predetermined mode upon the timer reaching the end of a predetermined time period, so as to cause an overcurrent condition which opens the overcurrent switch.

In certain present embodiments, such predetermined mode may comprise operating the micro controller so as to short the battery to ground.

In certain other embodiments, the method may further comprise operating the micro controller in normal power mode upon the timer reaching the end of the predetermined time. In certain of such alternative embodiments, the method may further comprise stopping the timer prior to operating the micro controller in normal power mode upon determination of the existence of an external supply voltage above a predetermined level.

In particular alternatives of the foregoing embodiments, the method may set the predetermined time period to a predetermined number of months. In selected embodiments, the timer may be provided as a function within the micro controller.

In selected other embodiments, determination of an external supply voltage to the micro controller dropping below a predetermined value may be provided as a function of the micro controller. In particular embodiments, the method may set the predetermined value to zero volts.

Per another present exemplary embodiment, present subject matter relates to a methodology for switching off a battery backed up micro controller, comprising providing a micro controller and an associated backup battery; providing a switching device between the battery and micro controller; starting a timer upon determination that an external supply voltage to the micro controller has dropped below a predetermined value; operating the micro controller to short the battery to ground upon the timer reaching the end of a predetermined time period; sensing an overcurrent condition due to shorting of the battery; and opening the switching device between the battery and micro controller.

In exemplary present variations of the foregoing, such switching device may comprise one of an overcurrent switch with current sensor, a push-button type circuit breaker, and a replaceable fuse.

In other present variations of such exemplary methodology, additional steps may include stopping the timer prior to operating the micro controller to short the battery to ground upon determination of the existence of an external supply voltage above a predetermined level; and setting the predetermined time period to a predetermined number of months.

It is to be understood that the present subject matter equally relates to corresponding apparatus. For example, the present subject matter also relates to an exemplary present battery protection circuit comprising a battery, a micro controller operable in a normal-power mode and a low-power mode, where the micro controller is configured to be powered in the normal-power mode by an external voltage supply and in the low-power mode by the battery, an overcurrent switch connected in series with the battery and the micro controller, and a timer configured to cause the micro controller to short the battery to ground at the end of a predetermined time period in the absence of the external voltage supply. With such arrangement and operation thereof, the overcurrent switch will open so as to disconnect the battery from the micro controller.

In certain embodiments, the timer is provided as a portion of the micro controller. In particular embodiments, the predetermined time period is set for a predetermined number of months and in selected particular embodiments, an external voltage monitor is provided and configured to stop the timer upon detection of an external voltage above a predetermined value.

Additional objects and advantages of the present subject matter are set forth in, or will be apparent to, those of ordinary skill in the art from the detailed description herein. Also, it should be further appreciated that modifications and variations to the specifically illustrated, referred and discussed features, elements, and steps hereof may be practiced in various embodiments and uses of the present subject matter without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a schematic block diagram of portions of an exemplary electric meter incorporating the present technology; and;

FIG. 2 is a flow chart illustrating an exemplary embodiment of the methodology of the present technology.

Repeat use of reference characters throughout the present specification and appended drawings is intended to represent same or analogous features, elements, or steps of the present subject matter.

### DETAILED DESCRIPTION OF THE PREFERRED EMBODIMENTS

As discussed in the Summary of the Invention section, the present subject matter is particularly concerned with improved methodology for turning off Micro Controller Units (MCUs) in meter registers.

As previously noted, it has been found that in certain instances, customers may store electricity meters for extended periods of time after manufacture and before deploying them to the field. In certain cases, the storage time may be sufficiently long as to substantially deplete the battery backup energy store. To address such problem, there is provided in accordance with present technology a mechanism whereby power to the MCU is turned off completely after a predetermined time following loss of input voltage to the meter. Generally the predetermined time will correspond to a selected number of months. It should be appreciated that loss of input voltage also includes those times where no input voltage has been applied such as immediately following completion of manufacture.

One aspect hindering implementation of such an operational plan or methodology, however, is the fact that many Micro Controller Units (MCUs) are not configured internally to actually turn off their battery supply. Generally such is because the MCUs lack an internal switch. In theory, one might consider that an internal battery switch might be addable to an MCU, but such a customization could in some circumstances be an undesired solution.

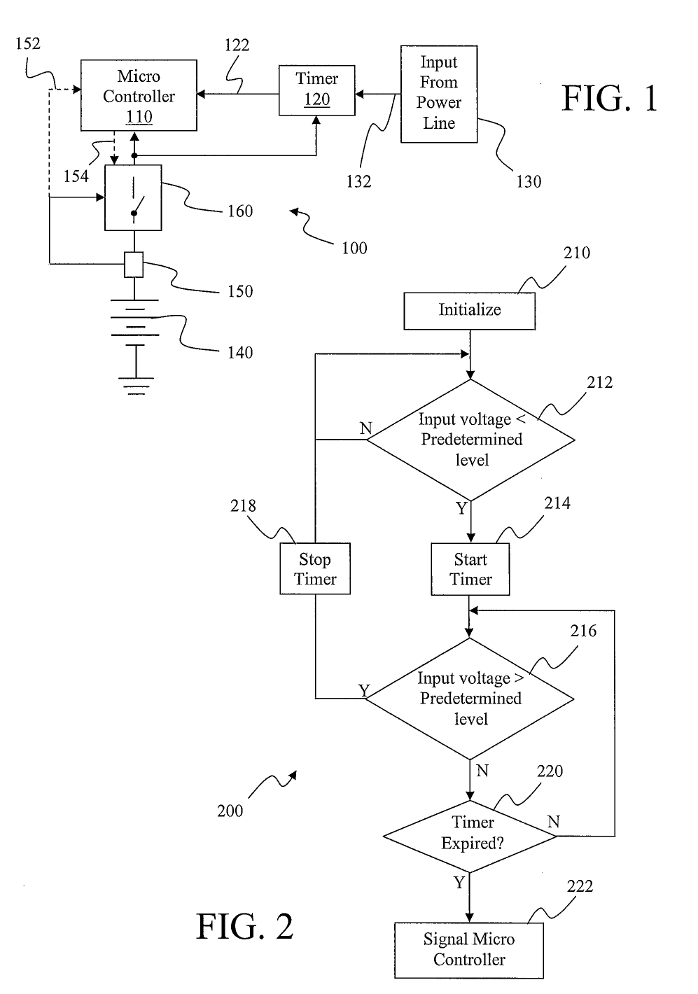

In accordance with present technology, such issue is instead addressed by, in combination with other features and arrangements, inserting a battery-protection overcurrent switch circuit between an MCU and its associated battery. Thus, as illustrated in present FIG. 1, there is shown a schematic block diagram of portions of an electric meter 100 incorporating the present technology (and representing several embodiments of the present technology). Electric meter 100, as will be readily recognized by those of ordinary skill in the art, comprises a great number of sub-components not presently illustrated including, for example, registers, i.e., data storage components, input connections for monitoring voltage and current, displays and associated display drivers, etc., all of which are presently unillustrated for clarity of presentation as to the present subject matter but which are otherwise well understood by those of ordinary skill in the art without requiring additional, detailed disclosure.

Illustrated in FIG. 1 is a partial block diagram of an electricity meter generally 100 incorporating the present technology including micro controller 110 that in normal operation controls the general operations of the electricity meter 100 including, but not necessarily limited to, monitoring, recording, and reporting on energy consumption by unillustrated loads coupled to electricity meter 100.

Also represented by the illustration is a timer generally 120 configured to transmit a signal over line 122 to micro controller 110. Timer 120 has as one input thereto a signal via line 132 from input 130 representing the voltage applied to a voltage sensing input terminal on electricity meter 100 that normally monitors the line input voltage to electricity meter 100. Further included in electricity meter 100 is backup battery generally 140 configured to supply operating power to micro controller 110 and timer 120. It should also be noted that timer 120 may, in fact, in accordance with the present subject matter, correspond to a timing function incorporated within the software/firmware operating in conjunction with micro controller 110, although timer 120 may equally well also correspond to a separate item, as presently illustrated.

In accordance with present technology, an overcurrent switch circuit (corresponding in the present representative embodiment to current sensor generally 150 and switch generally 160) is incorporated in series into the power line (unlabeled) from backup battery 140 to micro controller 110. Current sensor 150 monitors the current from backup battery 140 to micro controller 110 and, upon sensing current exceeding a predetermined level, triggers switch 160 to open, thus effectively disconnecting backup battery 140 from micro controller 110.

As with the possible incorporation of timer 120 as a software/firmware component within micro controller 110, those of ordinary skill in the art will appreciate that the current level detection function and associated trigger functions may optionally be carried out by micro controller 110 as illustrated by dashed lines 152, 154, respectively. Further, it will be appreciated by those of ordinary skill in the art that the overcurrent switch may also correspond to a push-button type circuit breaker or even a replaceable fuse. In other configurations for practice in accordance with the present subject matter, the subject overcurrent switch may itself be integrated into a power supply integrated circuit.

With present reference to FIG. 2, there is provided a flow chart generally 200 illustrating an exemplary embodiment of methodology of the present technology. As may be seen from such flow chart 200, an initialization step 210 may correspond to the final manufacture of an electric meter incorporating the present technology. Such an electric meter is preferably per the illustrated embodiment configured to monitor input voltage (step 212) and, in the case of the present technology will start a timer (step 214) if the input voltage to the electric meter falls below a predetermined level. Generally such predetermined level will preferably be close to zero volts to detect perceived storage of the electric meter.

After the timer is started, the input voltage is monitored at step 216 to determine whether such voltage has risen above a predetermined value, to detect perceived installation of the electric meter. If such an increase in voltage is detected, the method stops the timer at step 218 and loops back to step 212 to again monitor the input voltage. On the other hand, if the input voltage remains below the predetermined value established by step 212 until after the timer has expired at step 220, a signal will be sent to the micro controller (step 222) to force it to operate in its normal power mode. It will be recalled that in instances of storage, i.e., with no power supplied to the electric meter, such meters generally are configured to operate in a low power mode such that minimum operating power is supplied by the backup battery.

By instructing the micro processor to operate in its normal power mode despite the fact that no external power is available, the current drain from the backup battery will easily exceed an amount detectable by the overcurrent switch, and will cause such switch to open, so as to intentionally remove all power from the micro controller.

In accordance with present technology, significant advantage may be obtained in those instances where overcurrent protection has already been provided for an electricity meter to prevent accidental overcurrent on an associated battery. In such instance, the advantages of the present technology may be implemented at almost no additional cost.

In instances where the micro controller 110 is provided with a form of internal switch, the present subject matter (both methodology and apparatus) may be modified to provide effective solutions, that is, alternative embodiments of the present subject matter. Specifically, instead of switching the micro controller to a normal power mode (after a predetermined time period), the internal switch of the micro controller can be configured and used so as to short the battery to ground. Also, the overcurrent switch may be configured to sense an overcurrent condition to such intentional shorting of the battery, for opening the switching device between the battery and micro controller. Such alternative embodiments for disconnecting a battery from the micro controller are equally represented by the subject Figures and fully encompassed by the present subject matter.

Selected combinations of aspects of the disclosed technology correspond to a plurality of different embodiments of the present subject matter. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure and appended claims is by way of example rather than by way of limitation, and the subject disclosure does not preclude inclusion of such modifications, variations and/or additions to the present subject matter as would be readily apparent to one of ordinary skill in the art.

What is claimed is:

1. A method for switching off a battery backed up micro controller, comprising:
providing a micro controller and an associated backup battery;
providing an overcurrent switch between the battery and micro controller;
starting a timer upon determination that an external supply voltage to the micro controller has dropped below a predetermined value; and
upon the timer reaching the end of a predetermined time period, operating the micro controller in a predetermined manner so as to cause an overcurrent condition which opens the overcurrent switch.

2. A method as in claim 1, wherein the predetermined manner comprises operating the micro controller so as to short the battery to ground.

3. A method as in claim 1, wherein the predetermined manner comprises operating the micro controller in normal power mode.

4. A method as in claim 3, further comprising stopping the timer prior to operating the micro controller in normal power mode upon determination of the existence of an external supply voltage above a predetermined level.

5. A method as in claim 1, further comprising setting the predetermined time period to a predetermined number of months.

6. A method as in claim 1, wherein the timer is provided as a function within the micro controller.

7. A method as in claim 1, wherein determination of an external supply voltage to the micro controller dropping below a predetermined value is provided as a function of the micro controller.

8. A method as in claim 7, further comprising setting the predetermined value to zero volts.

9. A method for switching off a battery backed up micro controller, comprising:
providing a micro controller and an associated backup battery;
providing a switching device between the battery and micro controller;
starting a timer upon determination that an external supply voltage to the micro controller has dropped below a predetermined value;
operating the micro controller to short the battery to ground upon the timer reaching the end of a predetermined time period;
sensing an overcurrent condition due to shorting of the battery; and
opening the switching device between the battery and micro controller.

10. A method as in claim 9, wherein the switching device comprises one of an overcurrent switch with current sensor, a push-button type circuit breaker, and a replaceable fuse.

11. A method as in claim 9, further comprising:
stopping the timer prior to operating the micro controller to short the battery to ground upon determination of the existence of an external supply voltage above a predetermined level; and
setting the predetermined time period to a predetermined number of months.

12. A battery protection circuit, comprising:
a battery;
a micro controller operable in a normal-power mode and a low-power mode, said micro controller being configured to be powered in said normal-power mode by an external voltage supply and in said low-power mode by said battery;
an overcurrent switch connected in series with said battery and said micro controller; and
a timer configured to cause said micro controller to short said battery to ground at the end of a predetermined time period in the absence of said external voltage supply, so that said overcurrent switch will open so as to disconnect said battery from said micro controller.

13. A circuit as in claim 12, wherein said timer comprises a portion of said micro controller.

14. A circuit as in claim 12, wherein said predetermined time period comprises a predetermined number of months.

15. A circuit as in claim 12, further comprising an external voltage monitor configured to stop said timer upon detection of an external voltage above a predetermined value.
